(19) United States
(12) Patent Application Publication
(10) Pub. No.: US 2008/0142289 A1
(43) Pub. Date: Jun. 19, 2008

(54) Engine room frame structure of fuel cell vehicle

(75) Inventors: Dong Soo Yang, Gyeonggi-do (KR); Seng Jong Lyoo, Gyeonggi-do (KR); Hwan Ik Kim, Gyeonggi-do (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 11/983,141

(22) Filed: Nov. 6, 2007

(30) Foreign Application Priority Data
Dec. 18, 2006 (KR) 10-2006-0129106

(51) Int. Cl. B60K 1/04; B60K 8/00

(52) U.S. Cl. 180/299; 180/312

(57) ABSTRACT

The present invention provides an engine room frame structure of a fuel cell vehicle that improves assembly process by a module operation and reduces the number of assembly processes, thus improving productivity. The engine room frame structure of a fuel cell vehicle includes: a sub-frame on which a motor 11, an air blower 12, and component parts 13 of an electrical system and a fuel cell system are mounted in the form of a module; and a main frame 20 on which the sub-frame 10 is mounted.

### CROSS-REFERENCE TO RELATED APPLICATION

This application claims the benefit under 35 U.S.C. §119(a) on Korean Patent Application No. 10-2006-0129106 filed on Dec. 18, 2006, the entire contents of which are incorporated herein by reference.

### BACKGROUND

(a) Technical Field

The present invention relates to an engine room frame structure of a fuel cell vehicle.

(b) Background Art

A fuel cell vehicle is equipped with a fuel cell generation system that generates electric power for driving a motor to operate a vehicle.

In the fuel cell vehicle, a fuel system and an electrical system are provided. The fuel and electrical systems are made of plurality of component parts. For example, the fuel system includes a fuel cell and a high-pressure hydrogen tank and the electrical system includes a power control unit, a motor, a secondary cell. Each of these parts is arranged in an appropriate position so as to perform its function efficiently.

In the meantime, most of the component parts have limitation on their positions due to inherent characteristics of each component. For example, a component enclosing hydrogen gas should be positioned away from a high-voltage power line due to its explosiveness. Also, for example, in order to prevent a fuel pipe and the high-voltage power line from getting close to each other by a vehicle collision, the fuel system is positioned in a rear portion of the vehicle and the electric driving system is arranged in a front portion of the vehicle, thus minimizing the possibility of the ignition of leaking hydrogen gas.

U.S. Pat. No. 6,968,815 B2 discloses a fuel cell vehicle for reducing vibration of an air compressor that is an air supply unit of a fuel cell. This fuel cell vehicle has a structure in which a main motor is positioned on the upper portion of a frame, a motor for driving the air compressor is mounted using a rubber, and a cooling module is arranged adjacent to one side of the compressor. As the compressor is arranged on the upper portion of the main motor and thereby mounted indirectly on the frame, the stability of the structure is deteriorated.

U.S. Pat. No. 6,994,178 B2 discloses a structure of a driving motor, a power controller, a fuel cell and a frame as shown in FIG. 2. In the structure, the driving motor 2 is arranged on the upper portion of the frame 1, the fuel cell 3 is positioned on the upper portion of the driving motor 2, and the power controller 4 is stacked on the upper portion of the fuel cell 3. Since the process of assembling the respective driving motor 2, the fuel cell 3 and the power controller 4 in the sequential order is complicated, the manufacturing cost is increased due to the increase in the number of assembly processes.

The information disclosed in this Background section is only for enhancement of understanding of the background of the invention and should not be taken as an acknowledgement or any form of suggestion that this information forms the prior art that is already known to a person skilled in the art.

### SUMMARY OF THE INVENTION

The present invention has been made in an effort to solve the above problems. One object of the present invention is to provide an engine room frame structure of a fuel cell vehicle, which can be manufactured at a lower costs and in a simpler method, resulting in improved productivity.

In a preferred embodiment, the present invention provides an engine room frame structure of a fuel cell vehicle, which includes a main frame and a sub-frame. The sub-frame includes a motor, an air blower, and component parts of an electrical system and a fuel cell system mounted thereon in the form of a module. The sub-frame is mounted on the main frame.

In another preferred embodiment, the air blower is mounted in front portion of the motor.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like. The present systems will be particularly useful with a wide variety of motor vehicles.

### BRIEF DESCRIPTION OF THE DRAWINGS

FIG. 1 is a diagram showing a conventional engine room frame structure;

FIG. 2 is an exploded view showing a structure in which a sub-frame module is mounted on a main frame in accordance with the present invention;

FIG. 3 is a diagram showing a structure in which the sub-frame module is mounted on the main frame in accordance with the present invention; and

FIG. 4 is a diagram showing a structure in accordance with the present invention is applied in a vehicle.

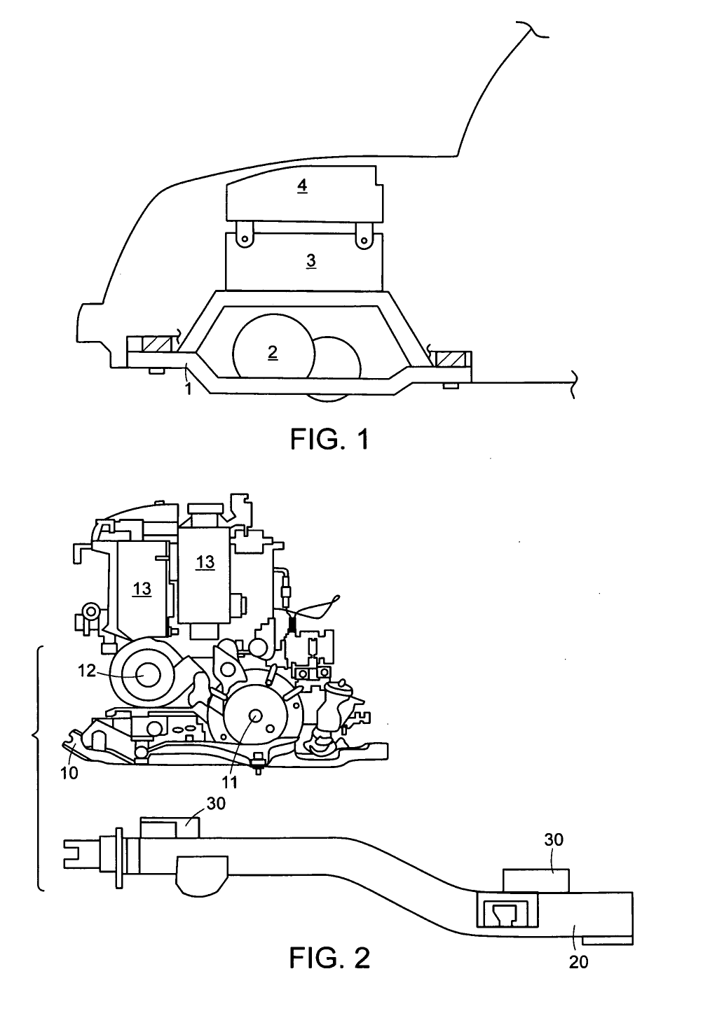

Reference numerals set forth in the Drawings includes reference to the following elements as further discussed below:

| | |
|---|---|
| 10: sub-frame | 11: motor |
| 12: air blower | 20: main frame |
| 30: mounting member | |

### DETAILED DESCRIPTION

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

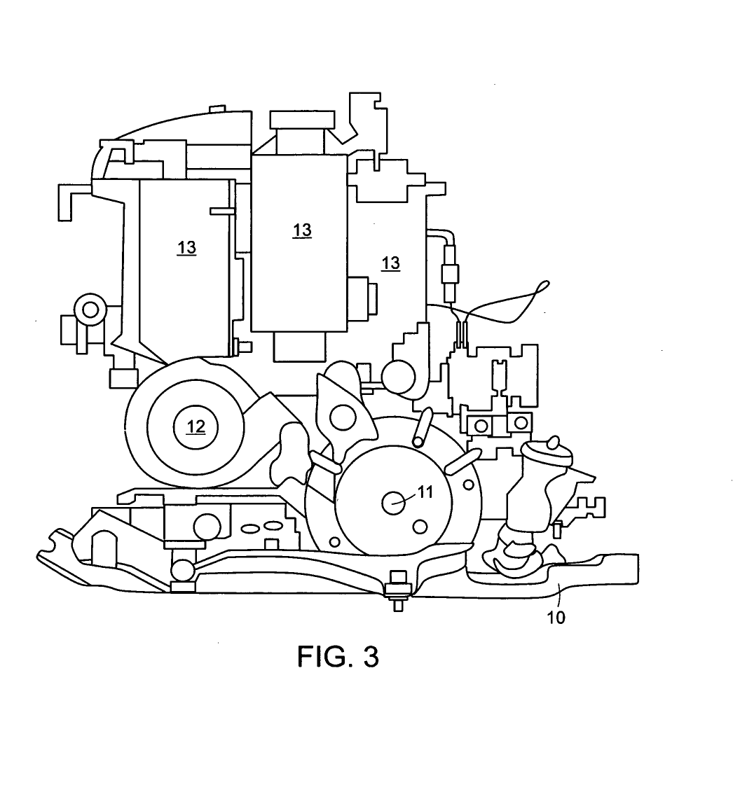

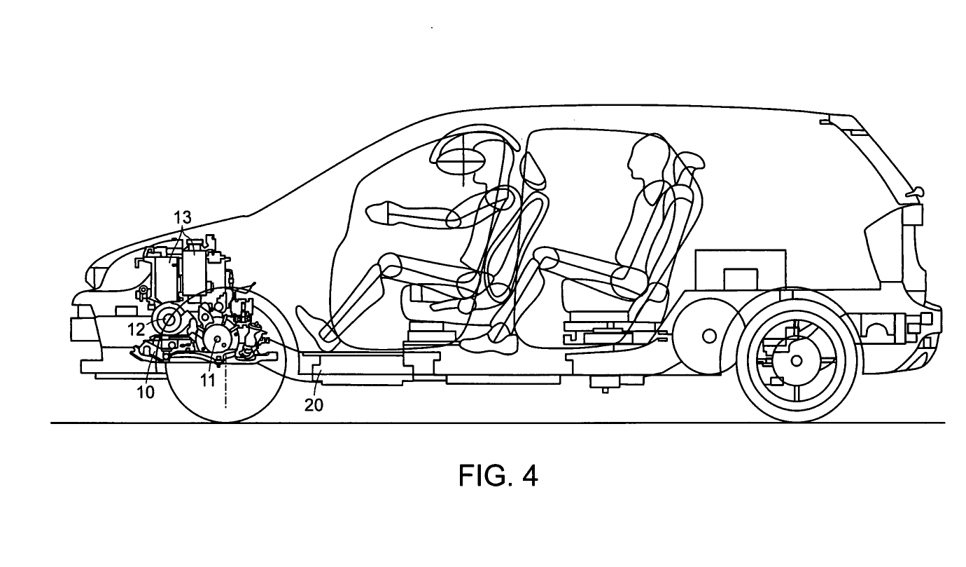

FIG. 2 is an exploded view showing a structure in which a sub-frame 10 module including various component parts is mounted on a main frame 20 in accordance with the present invention, FIG. 3 is a diagram showing a structure in which the sub-frame module is mounted on the main frame in accordance with the present invention, and FIG. 4 is a diagram showing a structure in accordance with the present invention is applied in a vehicle.

In a fuel cell vehicle, a motor 11, an air blower 12, and various component parts of an electrical system and a fuel cell system such as APS, TMS parts, MCU, and the like are mounted mainly in a front portion of a main frame 20.

In the present invention, the above-described parts such as the motor 11, the air blower 12, and component parts of the electrical system and the fuel cell system are mounted on the upper portion of a sub-frame 10 using separate mounting members.

Preferably, the APS, TMS parts, MCU, and the like may be mounted in appropriate positions using mounting members such as a rubber.

Moreover, it is possible to mount the APS, TMS parts, MCU, and the like on the upper portion of the motor 11 already mounted on the sub-frame 10 using the mounting members such as a rubber.

Like this, the sub-frame 10 including the motor 11, the air blower 12, and component parts of the electrical system and the fuel cell system, respectively mounted on the upper portion thereof in the form of a module, is mounted on the upper portion of the main frame 20.

A mounting member 30 such as a rubber is disposed between the sub-frame 10 and the main frame 20.

Since the mounting member 30 can be a widely used vibration attenuation element mounted in a state that a bolt surrounded by a rubber is engaged with a nut to attenuate the vibration, its detailed description will be omitted.

Meanwhile, it is preferable that the air blower 12 be mounted directly on the sub-frame 10 and, more preferably, in front of the motor 11 to reduce interior noise of the vehicle.

As described above, the present invention improves the assembly process by mounting the sub-frame 10 including the motor 11, the air blower 12, and the various component parts such as the APS, TMS parts, MCU, and the like, respectively mounted on the upper portion thereof in the form of a module, on the upper portion of the main frame 20.

Accordingly, the assembly process is remarkably improved due to the module operation. Moreover, the number of assembly processes is reduced to improve productivity and earn economic profits due to the decrease in the manufacturing cost.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An engine room frame structure of a fuel cell vehicle, comprising:
a sub-frame on which a motor, an air blower, and component parts of an electrical system and a fuel cell system are mounted in the form of a module; and
a main frame on which the sub-frame is mounted.

2. The engine room frame structure of claim 1, wherein the air blower is mounted in front portion of the motor.
